(19) United States
(12) Patent Application Publication
(10) Pub. No.: US 2011/0294620 A1
(43) Pub. Date: Dec. 1, 2011

(54) POWER TRANSMISSION SYSTEM FOR HYBRID VEHICLE

(76) Inventors: Steve Pruitt, Sandy, UT (US); Alden Rix, Salt Lake City, UT (US)

(21) Appl. No.: 13/117,129

(22) Filed: May 26, 2011

Related U.S. Application Data
(60) Provisional application No. 61/348,574, filed on May 26, 2010.

(51) Int. Cl. B60W 20/00; F02B 61/00

(52) U.S. Cl. 477/5; 123/2; 903/930

(57) ABSTRACT

A power transmission system for transmitting power from a crank shaft of an engine to a drive shaft of a transmission gear box via a clutch assembly is disclosed. The clutch assembly facilitates co-rotation of the crank and drive shaft when engaged and allows relative rotation between the crank and drive shaft when not engaged. The system includes an electric motor with an input/output shaft and a gear assembly coupled to the input/output and drive shaft. Rotation of the drive shaft is transmitted to rotation of the input/output shaft via the gear assembly and rotation of the input/output shaft is transmitted to rotation of the drive shaft via the gear assembly. The drive shaft is drivable by the engine via the crank shaft when the clutch assembly is engaged and is drivable by the electric motor via the input/output shaft and gear assembly when the clutch assembly is not engaged.

### CROSS-REFERENCE TO RELATED APPLICATION

This application claims the benefit of U.S. Provisional Patent No. 61/348,574, filed May 26, 2010, which is incorporated herein by reference.

### FIELD

The present application is related to hybrid vehicle technology, and more particularly, to a transmission system for transferring power between an internal combustion engine and an electric motor

### BACKGROUND

So-called “hybrid” vehicles come in all shapes, sizes, and configurations. Conventionally, hybrid vehicles are selectively and/or cooperatively powered by an internal combustion engine and one or more alternative power sources, such as an electric motor. In some known hybrid vehicles, multiple electric motors are each secured to a respective wheel to directly drive the wheels. In other hybrid vehicles, electric motors drive the wheels of the vehicle using a transmission system independent of the transmission system of the internal combustion engine. In yet other hybrid vehicles, a transmission system of the vehicle includes multiple input shafts respectively coupled to the internal combustion engine and one or more electric motors.

Additionally, many electric drive systems on hybrid vehicles are not self-sustaining. For example, many systems do not include regenerative braking capability and recovered energy storage systems.

### SUMMARY

The subject matter of the present application has been developed in response to the present state of the art, and in particular, in response to the problems and needs in the art that have not yet been fully solved by currently available hybrid vehicles. Accordingly, the subject matter of the present application has been developed to provide a power transmission drive system, and associated apparatus and methods, for a hybrid vehicle that overcomes the shortcomings of the prior art.

According to one embodiment, a vehicle includes an internal combustion engine with a drive shaft and a transmission assembly with an input shaft and at least one output shaft. The output shaft is driven by the input shaft and the output shaft is coupled to at least one wheel to drive the at least one wheel. The vehicle includes a clutch assembly that is coupled to the drive shaft of the internal combustion engine and input shaft of the transmission assembly. The clutch assembly is actuatable between a first configuration and a second configuration. The first configuration facilitates co-rotation between the drive shaft of the internal combustion engine and the input shaft of the transmission assembly and the second configuration facilitates relative rotation between the drive shaft of the internal combustion engine and the input shaft of the transmission assembly. The vehicle also includes an electric motor coupled to the input shaft of the transmission assembly. The electric motor is configured to be driven by the input shaft when the clutch assembly is in the first configuration and drive the input shaft when the clutch assembly is in the second configuration.

In certain implementations, the clutch is manually actuatable between the first and second configurations. In other implementations, the clutch can be automatically actuatable between the first and second configurations. Actuation between the first and second configurations can be based at least partially on a position of a throttle of the internal combustion engine.

According to some implementations of the vehicle, the vehicle includes a power control unit that is operable to control actuation of the clutch assembly between the first and second configurations based on at least one operating condition selected from the group consisting of throttle position of an intake throttle, a level of fuel stored on the vehicle, a level of energy stored in the batteries of the vehicle, speed of the engine, and speed of the vehicle.

In yet some implementations of the vehicle, a power control unit of the vehicle is operable to control the transmission of electrical power between an energy storage system of the vehicle and the electric motor. The power control unit can be operable in a power mode and energy recovery mode. The power control unit directs the transmission of power from the energy storage system to the electric motor in the power mode and directs the transmission of power from the electric motor to the energy storage system in the energy recovery mode. The clutch assembly is in the second configuration in the power mode and the first or second configuration in the energy recovery mode. Operation of the power control unit in one of the power mode and energy recovery mode is based on at least one operating condition selected from the group consisting of throttle position of an intake throttle, a level of fuel stored on the vehicle, a level of energy stored in the batteries of the vehicle, speed of the engine, and speed of the vehicle.

According to certain implementations of the vehicle, the clutch assembly includes a flywheel that is co-rotatably coupled to the drive shaft and a clutch plate co-rotatably coupled to the input shaft of the transmission assembly. In the first configuration, the flywheel is frictionally engaged with the clutch plate. In the second configuration, the flywheel is spaced-apart from the clutch plate. The electric motor of the vehicle can be coupled to the input shaft of the transmission assembly via a gear box comprising a plurality of gears.

In another embodiment, a power transmission system for selectively transmitting power from a crank shaft of an internal combustion engine to a drive shaft of a transmission gear box via a clutch assembly is disclosed. The clutch assembly facilitates co-rotation of the crank shaft and drive shaft when engaged and allows relative rotation between the crank shaft and drive shaft when not engaged. The power transmission system includes an electric motor with an input/output shaft and a gear assembly coupled to the input/output shaft and the drive shaft. Rotation of the drive shaft is transmitted to rotation of the input/output shaft via the gear assembly and rotation of the input/output shaft is transmitted to rotation of the drive shaft via the gear assembly. The drive shaft can be drivable by the internal combustion engine via the crank shaft when the clutch assembly is engaged and the drive shaft can be drivable by the electric motor via the input/output shaft and gear assembly when the clutch assembly is not engaged.

According to some implementations of the power transmission system, the gear assembly includes a transmission drive gear coupled directly to the input shaft of the transmission assembly. The transmission drive gear can include a central opening. The input shaft of the transmission assembly can extend through the central opening of the transmission drive gear. The central opening of the transmission drive gear may include a first set of splines and the input shaft of the transmission assembly may include a second set of splines. The first and second set of splines can be engageable to facilitate co-rotation of the transmission drive gear and the input shaft of the transmission assembly. The first set of splines can be formed in the transmission drive gear at an intermediate portion of the transmission drive gear.

In certain implementations of the system, the gear box is mounted vertically above the input shaft of the transmission assembly. Actuation of the clutch assembly between the first and second configurations can be based on user input. According to some implementations, the drive shaft can be drivable by the internal combustion engine via the crank shaft when the clutch assembly is engaged and the drive shaft can be drivable by the electric motor via the input/output shaft and gear assembly when the clutch assembly is not engaged.

In yet another embodiment, a method for transmitting power to the wheels of a vehicle includes disengaging a clutch assembly to drive an input shaft of a transmission assembly with a crankshaft of an internal combustion engine. The input shaft is coupled, directly or indirectly, to the wheels of the vehicle. The method further includes engaging a clutch assembly to prevent the crankshaft of the internal combustion engine from driving the input shaft of the transmission assembly. While the clutch assembly is engaged, the method includes driving the input shaft of the transmission assembly with an electric motor coupled to the input shaft.

Reference throughout this specification to features, advantages, or similar language does not imply that all of the features and advantages that may be realized with the present subject matter should be or are in any single embodiment or implementation of the subject matter. Rather, language referring to the features and advantages is understood to mean that a specific feature, advantage, or characteristic described in connection with an embodiment is included in at least one embodiment of the present subject matter. Discussion of the features and advantages, and similar language, throughout this specification may, but do not necessarily, refer to the same embodiment or implementation.

In some implementations, the method also includes recovering at least a portion of a rotational energy of the input shaft by transferring the portion of rotational energy to the electric motor via a coupling between the electric motor and the input shaft.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is schematic diagram of a power transmission system according to one representative embodiment;

FIG. 2 is an electric drive system of a power transmission system according to one representative embodiment; and

FIG. 3 is a schematic block diagram of an electric drive system according to one representative embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present subject matter. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present subject matter, however, absent an express correlation to indicate otherwise, an implementation may be associated with one or more embodiments.

Described herein are various embodiments of a power transmission system, method, and apparatus for a hybrid vehicle. Generally, the power transmission system includes a clutch regulated electric drive system with an electric motor coupled to the input shaft of the transmission gear box of the vehicle. Accordingly, rotation of the input shaft correspondingly rotates the electric motor. In a first configuration, the input shaft is driven or rotated by the internal combustion engine of the vehicle via a clutch assembly. The clutch assembly is operable to place the input shaft in co-rotational communication with the crank shaft of the engine. In a second configuration, the clutch assembly decouples the input shaft from the crank shaft such that the input shaft is able to freely rotate relative to the crank shaft. With the input shaft decoupled from the crank shaft, the electric motor can be actuated to drive or rotate the input shaft. Therefore, the hybrid vehicle can be selectively powered by an internal combustion engine or electric motor based on the actuation of a clutch assembly. Whether in the first or second configuration, at least a portion of the rotational energy of the input shaft can be stored in an energy recovery system by operating the electric motor as a generator.

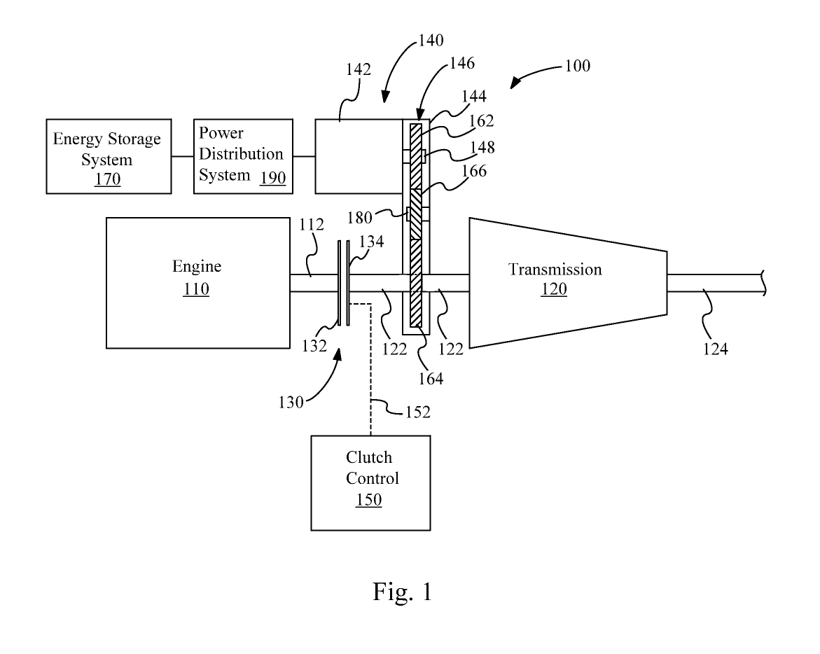

Referring to FIG. 1, and according to one embodiment, a power transmission system 100 includes an internal combustion engine 110 coupled to a transmission 120 via a clutch assembly 130. The internal combustion engine 110 can be any of various internal combustion engines known in the art, such as gasoline and diesel powered engines. The engine 110 is configured to rotatably drive a crank shaft 112, which is fixed to a flywheel 132 of the clutch assembly 130.

The transmission 120 can be any of various transmission assemblies known in the art configured to transfer torque from the drive shaft 112 to one or more output or drive shafts 124. Generally, the transmission 120 includes a housing or gearbox that houses a plurality of gears driven by an input shaft 122. The input shaft 122 is fixed to a clutch plate 134 of the clutch assembly 130. The plurality of gears of the transmission 120 adjusts the relative rate of rotation between the input shaft 122 and the output shaft 124 of the transmission 120. The output shaft 124 can extend from the transmission housing as shown or remain internal to the housing. For example, in some automotive applications, the output shaft 124 extends from the housing to couple the transmission 120 to a separate differential gear box, such as a rear differential, which transfers rotation of the output shaft to one or more wheel axles, such as rear axles of a vehicle. In other automotive applications, the differential is integrated into the transmission 120 (e.g., housed within the transmission housing) such that the output shaft 124 does not extend from the housing. In these applications, the integrated differential is coupled to one or more wheel axles to drive front wheels for front-mounted engines or to drive rear wheels in rear-mounted engines. Alternatively, the output shaft 124 can drive both front and rear wheels via a respective integrated or separate differential.

The clutch assembly 130 is configured to selectively couple and decouple the crank shaft 112 of the engine 110 and the input shaft 122 of the transmission 120. The flywheel 132 of the clutch assembly 130 is fixed to and co-rotates with the crank shaft 112. Similarly, the clutch plate 134 is fixed to and co-rotates with the input shaft 122. As defined herein, co-rotation means to rotate in conjunction with or at the same rate as another rotating body. The clutch assembly 130 includes biasing elements or springs (not shown) that bias the clutch plate 134 into contact with the flywheel 132. The contact surface of the clutch plate 134 frictionally engages the contact surface of the flywheel 132 to prevent relative rotation between the clutch plate and flywheel. In other words, the frictional engagement between the contact surfaces of the clutch plate 134 and flywheel 132 prevents slippage and induces co-rotation between the clutch plate and flywheel. The contact surfaces can be coated with a friction-inducing coating or have friction-inducing features formed thereon to promote frictional engagement between the clutch plate and flywheel.

The clutch assembly 130 is coupled to a clutch control 150 via a communication line 152. The clutch control 150 is configured to control the actuation or engagement of the clutch assembly 130 via the communication line 152. The clutch assembly 130 includes a clutch actuator (not shown), such as a throw-out bearing, that is actuatable to overcome the biasing force of the biasing elements to disengage the biasing elements from the clutch plate 134. Disengagement of the biasing elements from the clutch plate 134 removes the clutch plate from frictional engagement with the flywheel 132 and allows the clutch plate to rotate freely relative to the flywheel. Accordingly, the clutch control 150 is operable to engage the clutch assembly 130 to facilitate co-rotation between the clutch plate 134 and flywheel 132 and to disengage the clutch assembly 130 to facilitate relative rotation between the clutch plate and flywheel.

In some embodiments, the clutch control 150 is a manually operated clutch pedal and the communication line 152 is a mechanical linkage. The mechanical linkage is coupled to the clutch actuator such that depression of the clutch pedal causes the clutch actuator to disengage the clutch assembly 130.

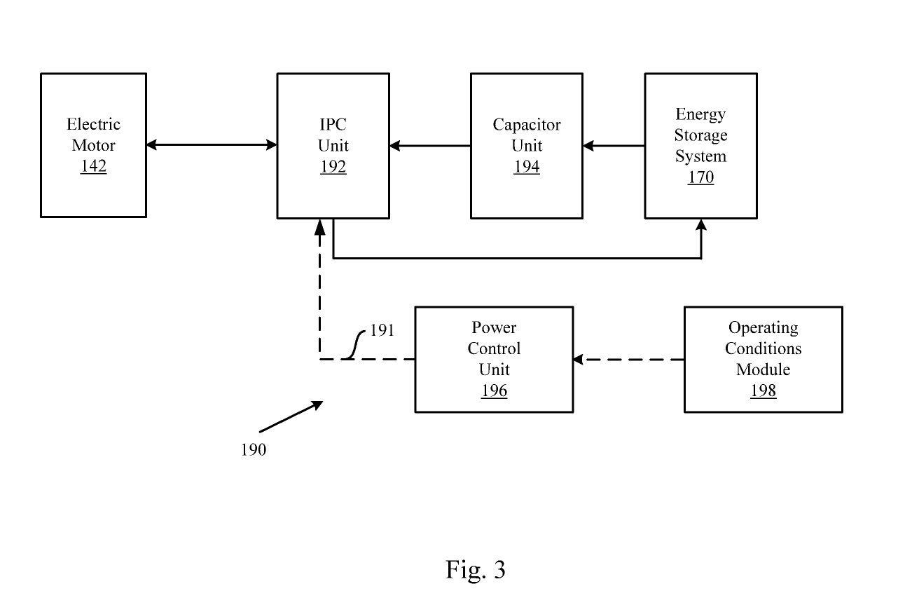

In other embodiments, the clutch control 150 is an electronic control module and the communication line 152 is an electrical communication line coupled to the clutch actuator via an actuation device, such as a solenoid valve. The electronic clutch module can be a separate module or form part of the power control unit 196 (see FIG. 3) or an electronic control module (ECM) of a vehicle. Generally, the control module sends electrically transmitted commands to the solenoid valve, which actuates the clutch actuator into and out of engagement with the clutch plate 134 in response to the commands. In some implementations, the transmission 120 is an automatic transmission as is known in the art and the control module actuates the clutch assembly 130 for automatically switching between transmission gears as is known in the art. In certain implementations, the control module is configured to engage and disengage the clutch assembly 130 automatically based on operating conditions of a vehicle, such as the throttle position of an intake throttle of the internal combustion engine, the level of fuel stored on the vehicle, the level of energy stored in the batteries of the vehicle, and the speed of the engine and/or vehicle. In other implementations, the control module is configured to engage and disengage the clutch assembly 130 manually based on input from a user, such as a button mounted on the dashboard of the vehicle. In some instances, the automatic control of the clutch assembly can be overridden by the manual input from the user.

Referring again to FIG. 1, the power transmission system 100 includes an electric drive system 140 coupled to the input shaft 122 of the transmission 120. The electric drive system 140 is configured to selectively drive the input shaft 122 and convert torque from the input shaft into energy storable in an energy storage system 170. The electric drive system 140 includes an electric motor 142 coupled to a gear housing 144 in which a gear assembly 146 is housed.

The electric motor 142 can be any of various electric motors known in the art without departing from the essence of the invention. Preferably, however, the electric motor 142 is any motor capable of functioning as a kinetic energy recovery system (KERS) motor. In one embodiment, the electric motor 142 is a 3-phase asynchronous electromagnetic induction motor capable of providing a peak power range between about 35 kw and about 45 kw. In other embodiments, however, the electric motor 142 can be capable of providing peak power greater than 45 kw depending at least partially on the amount of torque the power transmission system 100 and electric drive system 140 can sustain. In some embodiments, the electric motor 142 can be any of various other types of electric motors, such as a brushless DC motor. The electric motor 142 is powered by one or more batteries of the energy storage system 170 and can include a thermal management or dissipation system, such as a natural air cooling duct system fitted to a vehicle in which the system is housed, a liquid intercooler system, or a system utilizing advanced heat sink technology (e.g., using a frame of the vehicle as heat sinks).

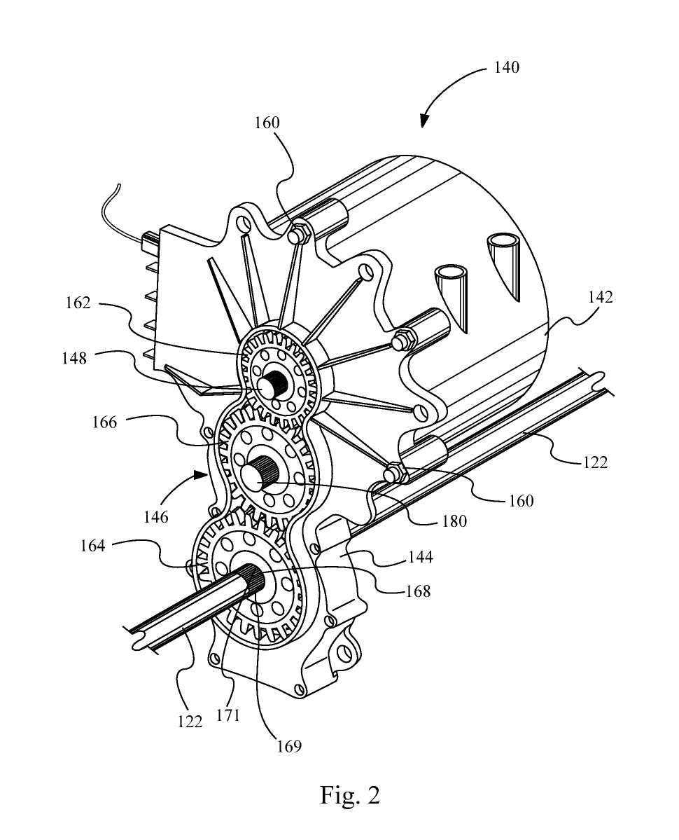

Referring to FIGS. 1 and 2, the electric motor 142 includes an input/output shaft 148 having a central axis. The electric motor 142 is secured to the gear housing 144 such that the input/output shaft 148 extends at least partially into the housing. In certain embodiments, the electric motor 142 is secured to the gear housing 144 using any of various fastening techniques, such as a nut and bolt arrangement 160. The portion of the input/output shaft 148 within the gear housing 144 engages the gear assembly 146 housed within the housing.

The gear assembly 146 includes a set or train of gears 162, 164, 166, which can be in a linear or planetary arrangement. The gear 162 is a motor gear to which the input/output shaft 148 of the electric motor 142 is engaged. Engagement between the shaft 148 and motor gear 162 facilitates co-rotation between the shaft and the motor gear. In some implementations, an end portion of the input/output shaft 148 includes splines that matingly engage corresponding splines formed along a central opening of the motor gear 162 as shown. The gear 164 is a transmission drive gear to which the input shaft 122 of the transmission 120 is engaged. The engagement between the input shaft 122 and the transmission drive gear 164 facilitates co-rotation between the input shaft and the transmission drive gear. In some implementations, an intermediate portion of the input shaft 122 includes splines 168 that matingly engage corresponding splines 169 formed along a central opening 171 of the transmission drive gear 164. The intermediate portion of the input shaft 122 can be defined as a portion of the input shaft between first and second ends of the input shaft. More specifically, the intermediate portion of the input shaft 122 is spaced away from the ends of the shaft and does not include the ends of the shaft. The gear 166 is an idler gear positioned between the motor gear 162 and transmission drive gear 164 in gear meshing engagement with the motor and transmission drive gears. The gear housing 144 includes a gear support shaft 180 that supports the idler gear 166 and about which the idler gear rotates. Additionally, the gear housing 144 can act as a lubricant reservoir for continually lubricating the gears 162, 164, 166 of the gear assembly 146 during actuation of the gear assembly.

The gear assembly 146 transfers rotational forces (e.g., torque) from the input/output shaft 148 to the transmission input shaft 122 and from the transmission input shaft to the input/output shaft. The idler gear 166 is configured to effectively decrease the motor-to-axle gear ratio between the motor gear 162 and transmission drive gear 164. In other words, the idler gear 166 causes the transmission drive gear 164 to rotate slower than the input/output shaft 148. The size and tooth-count of the idler gear 166 can be selected to provide a desirable motor-to-axle gear ratio, such as 16:1 in some embodiments. In some embodiments, the motor-to-axle gear ratio of the gear assembly 146 can be changed in situ by replacing one idler gear 166 having a first configuration with another idler gear having a second configuration. In one implementation, the gear housing 144 can include a removable cover that overlays the gears 162, 164, 166. Accordingly, a user of the power transmission system 100 can easily adjust the motor-to-shaft gear ratio of the gear assembly 146 based on the type of application for or conditions in which the power transmission system (i.e., a vehicle in which the system is housed) will be used. For example, for high-speed applications, the motor-to-axle gear ratio desirably is higher compared to low-speed applications. Also, if the size of the tires of a vehicle is adjusted, a user can easily modify the gear reduction ratio to compensate for the change.

The electric drive system 140 can be secured relative to the input shaft 122 of the transmission 120 in any of various ways without departing from the essence of the invention. In one implementation, the gear housing 144 is secured (e.g., bolted) directly to the transmission housing 120. In other implementations, the gear housing 144 can be secured to a frame of a vehicle. Further, in some embodiments, as shown in FIG. 1, the gear housing 144 is mounted vertically above the input shaft 122 of the transmission 120. More specifically, each gear 162, 164, 166 of the train of gears is positioned vertically relative to each other. In alternative embodiments, the gear housing 144 can be mounted laterally adjacent the input shaft 122 or below the input shaft as desired.

As shown in FIG. 1, the electric motor 142 of the electric drive system 140 is electrically coupled to the energy storage system 170 via a power distribution system 190. The energy storage system 170 receives power from and supplies power to the electric motor 142 via the power distribution system 190. In certain implementations, the energy storage system 170 includes one or more rechargeable batteries. The power distribution system 190 controls the timing and amount of power transmitted between the energy storage system 170 and the electric motor 142.

Referring to FIG. 3, the power distribution system 190 includes an inverter power control (IPC) unit 192, a capacitor unit 194, a power control unit 196, and an operating conditions module 198. The IPC unit 192 is configured to direct power between the batteries of the energy storage system 340 and the electric motor 142. Generally, the capacitor unit 194, which is an ultracapacitor in some embodiments, facilitates the efficient transfer of power to and from the batteries of the energy storage system 340. The electric motor 142, energy storage system 170, IPC unit 192, and capacitor unit 194 are in electric power supplying and/or receiving communication with each other via respective electric power input and output lines (as represented by solid lines in FIG. 3).

The IPC unit 192 of the power distribution system 190 is configured to convert a DC power signal to an AC power signal and vice versa. The IPC unit 192 controls the actuation of the electrical motor 142 by supplying variable amounts of power to the motor. The motor 142 responds to the supply power by rotating the input/output shaft 148 at a rate corresponding with the amount of supplied power. The timing and amount of power supplied to the motor 142 are controlled by a power control unit 196. The power control unit 196 can be part of the IPC unit 192. Alternatively, the power control unit 196 can be separate units or form part of the EMC of a vehicle, and communicate with the IPC unit 192 over an electrical communication line (as represented by dashed line 191 in FIG. 3).

As discussed above, the capacitor unit 194 is configured to increase the rate (e.g., efficiency) at which power can be supplied from the batteries of the energy storage system 170 to the IPC unit 192. However, in certain implementations, the power distribution system 190 does not include a capacitor unit 194 such that energy is delivered to the electric motor 142 directly from the batteries. In other implementations, the power distribution system 190 does not include an energy storage system 170 such that the capacitor is the only energy storage mechanism. Although the power distribution system shown includes a single IPC unit 192 and capacitor unit 194, in other embodiments, a power distribution system can include more than one IPC and capacitor unit.

As discussed above, the energy storage system 170 includes a plurality of batteries each configured to store and supply energy for operation of the electric drive system 140, as well as other electrical components of a vehicle if necessary. The batteries can be electrically coupled to each other in series, parallel, or any other suitable configuration. Further, the batteries can be lithium-ion, lithium-phosphate, lithium-titinate, nickel metal hydride, or other suitable battery types. Although the power transmission system 100 shown includes a single energy storage system 170, in some embodiments, the power transmission system can include more than one energy storage system.

In automotive applications, the energy storage system 170, IPC unit 192, and capacitor unit 194 are mounted to the vehicle. The energy storage system 170, IPC unit 192, and capacitor unit 194 can be mounted in close proximity relative to each other or mounted at strategic locations on the vehicle for accessibility, weight distribution, safety, and/or other considerations.

As discussed above, operation of the power transmission system 100 can be controlled by the power control unit 196 according to operating conditions of the engine 110 and/or vehicle in which the engine is housed. The operating conditions can be supplied to the power control unit 196 by an operating conditions module 198 either automatically, or manually based on user input. More specifically, based on operating conditions and/or user input, the power control unit 196 commands the IPC unit 192 to operate the electric drive system 140 in one of several modes, such as power mode, energy recovery mode, and inactive mode.

In the power mode, at least one of the IPC unit 192, power control unit 196, and ECM of a vehicle commands the clutch control 150 to disengage the clutch assembly 130 and decouple the input shaft 122 from the crank shaft 112. The IPC unit 192 then delivers power from the energy storage system 170 to the electric motor 142 to drive (e.g., apply torque to) the input shaft 122 via the gear assembly 146. Because the crank shaft 112 is decoupled from the input shaft 122, the electric motor 142 provides the sole means for driving the input shaft. When the electric motor 142 drives the input shaft 122 instead of the internal combustion engine 110, the overall horsepower of the vehicle can be increased with an associated increase in the fuel efficiency and decrease in harmful exhaust emissions.

Operation of the electric drive system 140 in the power mode can be triggered by any of various operating conditions. For example, it may be desirable to power a vehicle with the electric motor 142 instead of the internal combustion engine 110 once a speed of the engine reaches a predetermined threshold, a speed of the vehicle reaches a predetermined threshold, the level of fuel falls below a predetermined threshold, and/or the temperature of the engine reaches a predetermined threshold. Alternatively, operation of the electric drive system 140 in the power mode can be triggered by user input, such as a driver of a vehicle selecting an on-board button or switch when desired (e.g. when the driver desires more power).

In the energy recovery mode, the power control unit 196 commands the IPC unit 192 to operate the electric motor 142 as a generator to recover energy from the rotation of the input shaft 122. Accordingly, the electronic drive system 140 can operate in the energy recovery mode with the clutch assembly 130 engaged or not engaged. In other words, direct coupling of the electric drive system 140 to the input shaft 122 of the transmission 120 allows the system to recover energy from rotation of the input shaft 122 while the engine 110 is driving the input shaft during acceleration and deceleration, or when the engine is disengaged from the input shaft and a vehicle is effectively coasting. Because the rotational energy or torque is being transferred to the electric motor 142, operation of the electric drive system 140 in the energy recovery mode can assist in braking or decelerating a vehicle.

Operation of the electric drive system 140 in the energy recovery mode can be triggered by any of various operating conditions. For example, during a detected deceleration or braking of a vehicle, or when the amount of energy stored by the energy storage system 170 drops below a threshold. Vehicle braking can include engine braking and activation of wheel brakes. In some implementations, vehicle braking is detected by the operating conditions module 198 based on deceleration of the vehicle, signals to or from the wheel brakes, and/or other similar techniques.

In the inactive mode, the power supply and generator functionality of the electric motor 142 are disabled. Accordingly, although the gears of the gear assembly 146 and the input/output shaft 148 of the electric motor 142 rotate with rotation of the input shaft 122, power is not being supplied to nor is energy being recovered from the rotation of the input shaft.

Although the above embodiments of the power transmission system 100 are shown having a single electric drive system 140, in other embodiments, the power transmission system 100 can have more than one electric drive system. Moreover, in certain implementations, each of the multiple electric drive systems can have an electric motor with a different size or rating compared to the electric motors of the other systems, as well as differently geared gear assemblies as desired. Additionally, although the above embodiments of the power transmission system 100 have been described in association with automotive applications, the elements of the system are equally applicable to non-automotive applications employing internal combustion engines.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

The present subject matter may be embodied in other specific forms without departing from its spirit or essential characteristics. The described embodiments are to be considered in all respects only as illustrative and not restrictive. The scope of the subject matter is, therefore, indicated by the appended claims rather than by the foregoing description. All changes which come within the meaning and range of equivalency of the claims are to be embraced within their scope.

What is claimed is:

1. A vehicle, comprising:
an internal combustion engine comprising a drive shaft;
a transmission assembly comprising an input shaft and at least one output shaft, the output shaft being driven by the input shaft and the output shaft being coupled to at least one wheel to drive the at least one wheel;
a clutch assembly coupled to the drive shaft of the internal combustion engine and input shaft of the transmission assembly, the clutch assembly being actuatable between a first configuration and a second configuration, wherein the first configuration facilitates co-rotation between the drive shaft of the internal combustion engine and the input shaft of the transmission assembly and the second configuration facilitates relative rotation between the drive shaft of the internal combustion engine and the input shaft of the transmission assembly; and
an electric motor coupled to the input shaft of the transmission assembly, the electric motor being configured to be driven by the input shaft when the clutch assembly is in the first configuration and drive the input shaft when the clutch assembly is in the second configuration.

2. The vehicle of claim 1, wherein the clutch is manually actuatable between the first and second configurations.

3. The vehicle of claim 2, wherein the clutch assembly is manually actuatable via a mechanical linkage.

4. The vehicle of claim 1, wherein the clutch is automatically actuatable between the first and second configurations.

5. The vehicle of claim 4, wherein automatic actuation between the first and second configurations is based at least partially on a position of a throttle of the internal combustion engine.

6. The vehicle of claim 1, further comprising a power control unit operable to control actuation of the clutch assembly between the first and second configurations based on at least one operating condition selected from the group consisting of throttle position of an intake throttle, a level of fuel stored on the vehicle, a level of energy stored in the batteries of the vehicle, speed of the engine, and speed of the vehicle.

7. The vehicle of claim 1, further comprising a power control unit operable to control the transmission of electrical power between an energy storage system of the vehicle and the electric motor, wherein the power control unit is operable in a power mode and energy recovery mode, wherein the power control unit directs the transmission of power from the energy storage system to the electric motor in the power mode and directs the transmission of power from the electric motor to the energy storage system in the energy recovery mode, and wherein the clutch assembly is in the second configuration in the power mode and the first or second configuration in the energy recovery mode.

8. The vehicle of claim 7, wherein operation of the power control unit in one of the power mode and energy recovery mode is based on at least one operating condition selected from the group consisting of throttle position of an intake throttle, a level of fuel stored on the vehicle, a level of energy stored in the batteries of the vehicle, speed of the engine, and speed of the vehicle.

9. The vehicle of claim 1, wherein the clutch assembly comprises a flywheel co-rotatably coupled to the drive shaft and a clutch plate co-rotatably coupled to the input shaft of the transmission assembly, and wherein in the first configuration the flywheel is frictionally engaged with the clutch plate and in the second configuration the flywheel is spaced-apart from the clutch plate.

10. The vehicle of claim 1, wherein the electric motor is coupled to the input shaft of the transmission assembly via a gear box comprising a plurality of gears.

11. A power transmission system for selectively transmitting power from a crank shaft of an internal combustion engine to a drive shaft of a transmission gear box via a clutch assembly, the clutch assembly facilitating co-rotation of the crank shaft and drive shaft when engaged and allowing relative rotation between the crank shaft and drive shaft when not engaged, the power transmission system comprising:
an electric motor comprising an input/output shaft; and
a gear assembly coupled to the input/output shaft and the drive shaft;
wherein rotation of the drive shaft is transmitted to rotation of the input/output shaft via the gear assembly and rotation of the input/output shaft is transmitted to rotation of the drive shaft via the gear assembly.

12. The power transmission system of claim 11, wherein the gear assembly comprises a transmission drive gear coupled directly to the input shaft of the transmission assembly.

13. The power transmission system of claim 12, wherein the transmission drive gear comprises a central opening, and wherein the input shaft of the transmission assembly extends through the central opening of the transmission drive gear.

14. The power transmission system of claim 13, wherein the central opening of the transmission drive gear comprises a first set of splines and the input shaft of the transmission assembly comprises a second set of splines, and wherein the first and second set of splines are engageable to facilitate co-rotation of the transmission drive gear and the input shaft of the transmission assembly.

15. The power transmission system of claim 14, wherein the first set of splines is formed in the transmission drive gear at an intermediate portion of the transmission drive gear.

16. The power transmission system of claim 11, wherein the gear box is mounted vertically above the input shaft of the transmission assembly.

17. The power transmission system of claim 11, wherein actuation of the clutch assembly between the first and second configurations is based on user input.

18. The power transmission system of claim 11, wherein the drive shaft is drivable by the internal combustion engine via the crank shaft when the clutch assembly is engaged and the drive shaft is drivable by the electric motor via the input/output shaft and gear assembly when the clutch assembly is not engaged.

19. A method for transmitting power to the wheels of a vehicle, comprising:
disengaging a clutch assembly to drive an input shaft of a transmission assembly with a crankshaft of an internal combustion engine, the input shaft being coupled to the wheels of the vehicle;
engaging a clutch assembly to prevent the crankshaft of the internal combustion engine from driving the input shaft of the transmission assembly; and
while the clutch assembly is engaged, driving the input shaft of the transmission assembly with an electric motor coupled to the input shaft.

20. The method of claim 19, further comprising recovering at least a portion of a rotational energy of the input shaft by transferring the portion of rotational energy to the electric motor via a coupling between the electric motor and the input shaft.
